(19) United States
(12) Patent Application Publication
(10) Pub. No.: US 2025/0380322 A1
(43) Pub. Date: Dec. 11, 2025

(54) METHOD OF CONTROLLING COMMUNICATION WITH DISPLAY DEVICE AND DISPLAY SYSTEM

(71) Applicant: SEIKO EPSON CORPORATION, Tokyo (JP)

(72) Inventor: Hirohiko KIHARA, MATSUMOTO-SHI (JP)

(21) Appl. No.: 19/232,167

(22) Filed: Jun. 9, 2025

(30) Foreign Application Priority Data
Jun. 10, 2024 (JP) 2024-093588

(51) Int. Cl. H04W 76/15; G06F 3/14; H04N 9/31

(52) U.S. Cl. CPC H04W 76/15; G06F 3/1454; H04N 9/31

(57) ABSTRACT

A display system including three or more communication terminals and a monitor includes establishing, with the monitor, first communication with a first communication terminal in which management authority for managing authorization of communication with the monitor is set and second communication with a second communication terminal, when authorization of third communication between a third communication terminal and the monitor is requested from the third communication terminal while the image is displayed in the display region, transmitting, with the monitor, to a management device in which the management authority is set, information indicating that authorization of the third communication is requested, outputting, with the management device, to the monitor, communication determination information for causing a user of the management device to determine whether to approve the authorization of the third communication, and establishing, with the monitor, the third communication when information indicating that the authorization of the third communication was approved is received from the management device.

The present application is based on, and claims priority from JP Application Serial Number 2024-093588, filed Jun. 10, 2024, the disclosure of which is hereby incorporated by reference herein in its entirety.

### BACKGROUND

### 1. Technical Field

The present disclosure relates to a method of controlling communication with a monitor and a display system.

### 2. Related Art

In related art, in order to cause a monitor such as a projector to display an image, a device such as a computer establishes communication between the device such as the computer and the monitor. For example, JP-A-2018-152663 discloses that a projector displays an image including an identification code on a projection surface in response to predetermined operation such as power-on and a user who uses the projector inputs the identification code displayed on the projection surface to an information terminal, whereby the projector establishes connection to the information terminal.
JP-A-2018-152663 is an example of the related art.

However, when three or more communication terminals are made connectable to one monitor, the following problem arises. Specifically, a situation is conceivable in which, while the monitor is displaying an image based on image data transmitted from a device that has already established connection to the monitor, a device that has not established connection to the monitor requests communication with the monitor. In this situation, if the monitor executes predetermined operation and displays an image including an identification code, there is a problem in that the display of the image based on the image data transmitted from the device that has established connection is hindered.

### SUMMARY

A method of controlling communication with a monitor according to an aspect of the present disclosure is a method of, in a display system including three or more communication terminals a monitor capable of and communicating with the three or more communication terminals, controlling communication with the monitor, the method including: establishing, with the monitor capable of displaying an image in a display region, first communication with a first communication terminal in which management authority for managing authorization of communication with the monitor is set among the three or more device and second communication with a second communication terminal among the three or more communication terminals; when authorization of third communication between a third communication terminal among the three or more communication terminals and the monitor is requested from the third communication terminal while the image is displayed in the display region, transmitting, with the monitor, to a management device that is a device in which the management authority is set, authorization request information indicating that authorization of the third communication is requested; when the authorization request information is received, outputting, with the management device, to the monitor, communication determination information for causing a user of the management device to determine whether to approve the authorization of the third communication; and establishing, with the monitor, the third communication when approval information indicating that the authorization of the third communication was approved is received from the management device.

A display system according to an aspect of the present disclosure is a display system including: three or more communication terminals; and a monitor capable of communicating with the three or more communication terminals, wherein the monitor is capable of displaying an image in a display region, first communication between a first communication terminal among the three or more communication terminals and the monitor and second communication between a second communication terminal among the three or more communication terminals and the monitor are established, management authority for managing connection to the monitor is set in the first communication terminal, when authorization of third communication between a third communication terminal among the three or more communication terminals and the monitor is requested from the third communication terminal while the image is displayed in the display region, the monitor transmits, to a management device that is a device in which the management authority is set, authorization request information indicating that authorization of the third communication is requested, when receiving the authorization request information, the management device outputs, to the monitor, communication determination information for causing a user of the first communication terminal to determine whether to approve the authorization of the third communication, and the monitor establishes the third communication when receiving, from the management device, approval information indicating that the authorization of the third communication was approved.

### BRIEF DESCRIPTION OF THE DRAWINGS

FIG. 1 is a diagram illustrating a display system according to a first embodiment.

FIG. 2 is a diagram illustrating an example of a configuration of the PC.

FIG. 3 is a diagram illustrating an example of a configuration of a projector.

FIG. 4 is a sequence diagram illustrating an example of an operation of the display system.

FIG. 5 is a flowchart illustrating an example of an operation of the projector.

FIG. 6 is a flowchart illustrating an example of communication request reception time processing.

FIG. 7 is a diagram illustrating an example of a communication determination image.

FIG. 8 is a flowchart illustrating an example of communication request reception time processing according to a second embodiment.

FIG. 9 is a flowchart illustrating an example of authorization request information transmission processing.

FIG. 10 is a flowchart illustrating an example of an operation of the projector in a first modification.

FIG. 11 is a flowchart illustrating an example of management authority PC resetting processing.

FIG. 12 is a diagram illustrating an example of a selection instruction image.

FIG. 13 is a flowchart illustrating an example of an operation of the projector in a second modification.

FIG. 14 is a flowchart illustrating an example of management authority PC resetting processing in the second modification.

FIG. 15 is a diagram illustrating an example of a selection instruction image.

FIG. 16 is a flowchart illustrating an example of image data reception time processing.

FIG. 17 is a flowchart illustrating an example of an operation of the projector in a third modification.

FIG. 18 is a flowchart illustrating an example of an operation of occupying mode release processing.

### DESCRIPTION OF EMBODIMENTS

Modes for implementing the present disclosure are explained below with reference to the drawings. Note that, in the drawings, dimensions and scales of portion are differentiated from actual ones as appropriate. Embodiments explained below are preferred specific examples of the present disclosure and, therefore, various technically preferable limitations are added to the embodiments. However, the scope of the present disclosure is not limited to these embodiments unless, in the following explanation, there is particularly description to the effect that the present disclosure is limited thereto.

### 1. First Embodiment

### 1-1. Overview of the First Embodiment

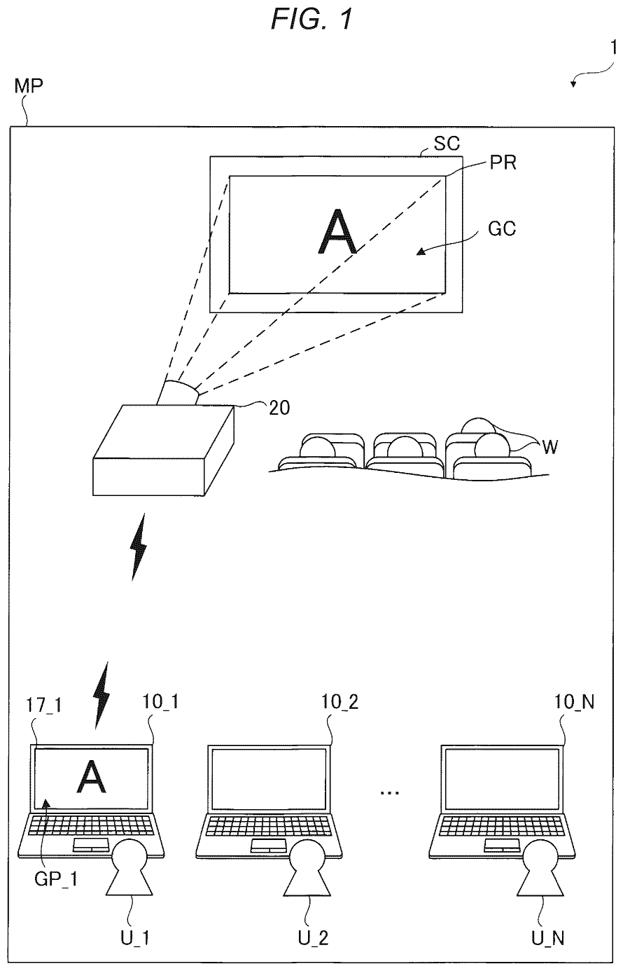

FIG. 1 is a diagram illustrating a display system 1 according to a first embodiment. The display system 1 is a system in which, in a venue MP, an image GC is displayed in a projection region PR of a projection surface SC visible from one or a plurality of spectators W and any one of three or more N presenters U explains the image GC. The venue MP is a place holding an event gathering the spectators W and may be either an indoor or outdoor place. The spectators W are specified or unspecified people. However, the spectators W may not be present and the presenters U other than the presenters U currently giving an explanation among the N presenters U may be temporary spectators. Examples of the event include a meeting, a lecture, and a class. The present embodiment is based on a premise that the N presenters U sequentially give explanations.

As illustrated in FIG. 1, the display system 1 includes N PCs 10 and a projector 20. PC is an abbreviation of Personal Computer. An i-th PC 10_i among the N PCs 10 is operated by an i-th presenter U_i among N people. Note that, in the present embodiment, although an image GC displayed in the projection region PR by the presenter U_i who operates the PC 10_i is explained for simplicity of explanation, a person who operates the PC 10_i and a person who explains the image GC may be different persons. The N PCs 10 are an example of “three or more communication terminals”. The presenter U is an example of a “user”. Projecting an image is an example of “display an image”. The projector 20 is an example of a “monitor”. The projection region PR is an example of a “display region”. The three or more of communication terminals provided in the display system 1 are not limited to the PCs and may be mobile terminals and smartphones.

In the following explanation, when elements of the same type are distinguished, reference signs are used like the PC 10_1 and the PC 10_2. On the other hand, when elements of the same type are not distinguished, only a common number of the reference signs is used like the PC 10.

The projector 20 is capable of communicating with the N PCs 10. In the present embodiment, the projector 20 and the N PCs 10 are capable of communicating with each other by wireless communication. Examples of the wireless communication include Wi-Fi, Bluetooth, and ZigBee. Wi-Fi and Bluetooth are registered trademarks. However, the projector 20 and each of the N PCs 10 may be capable of communicating with each other via relay equipment such as a wireless router or may be capable of communicating with each other via a network such as a LAN, a WAN, or the Internet. LAN is an abbreviation of Local Area Network.

Situations to which the display system 1 is applied include, for example, the following two situations. In a first situation to which the display system 1 is applied, an event is a meeting and a first presenter U_1 is an organizer of the meeting and gives an overall explanation concerning the meeting. Second and subsequent presenters U give explanations corresponding to agendas of the respective presenters. In a second situation to which the display system 1 is applied, the event is a class, the first presenter U_1 is a teacher in charge of the class, and the second and subsequent presenters U are students who attend the class. The teacher, who is the presenter U_1, explains content of a task given to the students in the previous class of this class. The students, who are the second and subsequent presenters U, explain answers to the task.

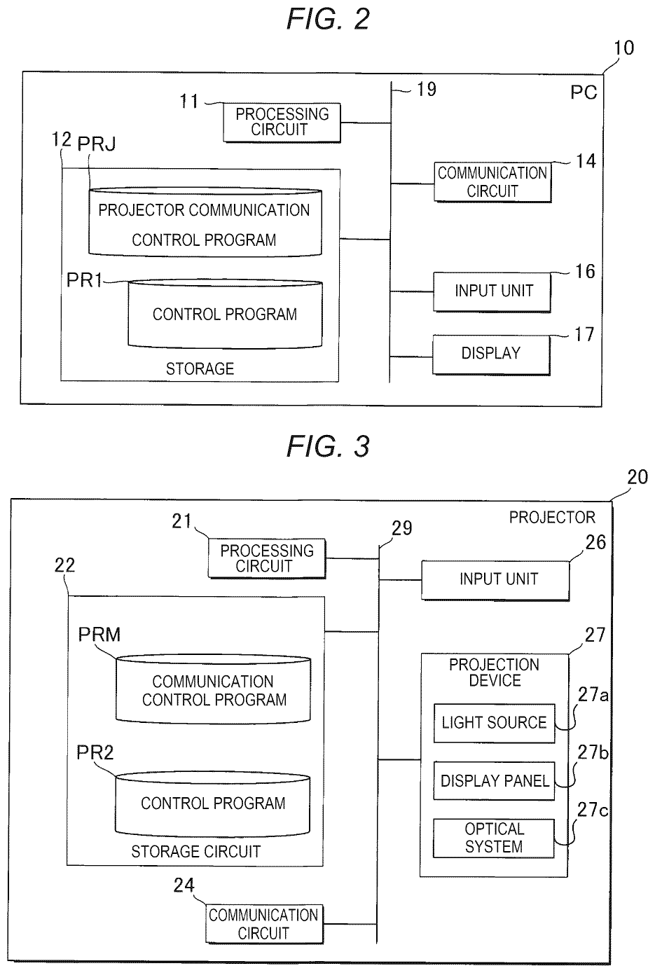

Configurations of the PC 10 and the projector 20 are explained with reference to FIGS. 2 and 3.

FIG. 2 is a diagram illustrating an example of the configuration of the PC 10. The PC 10 includes at least one processing circuit 11, a storage circuit 12, a communication circuit 14, an input unit 16, and a display 17. The processing circuit 11, the storage circuit 12, the communication circuit 14, the input unit 16, and the display 17 are coupled to one another by a bus 19 for communicating information.

The processing circuit 11 is a computer such as a CPU. The processing circuit 11 may be configured by one or a plurality of processors.

The storage circuit 12 includes a magnetic storage device, a flash ROM, or the like. The storage circuit 12 is a recording medium readable by the processing circuit 11 and stores a plurality of programs including a projector communication control program PRJ and a control program PR1 to be executed by the processing circuit 11, various information to be used by the processing circuit 11, and the like. The projector communication control program PRJ is an application program for controlling an operation of the PC 10 in the display system 1. For example, the PC 10 downloads the projector communication control program PRJ from a server managed by a developer of the projector 20. The control program PR1 is a system program including an OS of the PC 10.

The communication circuit 14 is hardware including a communication circuit for performing wireless communication with other communication terminals such as the projector 20. The communication circuit 14 is also described as, for example, network device, network controller, network card, or communication module.

The input unit 16 is equipment for the presenter U to input information. The input unit 16 is, for example, a mouse and a keyboard.

The display 17 is equipment that displays an image based on image data transmitted by the processing circuit 11. For example, the display 17 is an LCD or an organic EL display. LCD is an abbreviation of Liquid Crystal Display. EL is an abbreviation of Electro Luminescence. The input unit 16 and the display 17 may be integrally configured. The configuration in which the input unit 16 and the display 17 are integral is, for example, a touch panel.

In the following explanation, elements of the PC 10_i are sometimes explained with a reference sign “i” added thereto. For example, the display 17 provided in the PC 10_i is sometimes described as display 17_i. Further, an image displayed on the display 17_i is sometimes described as image GP_i.

FIG. 3 is a diagram illustrating an example of a configuration of the projector 20. The projector 20 includes at least one processing circuit 21, a storage circuit 22, a communication circuit 24, an input device 26, and a projection device 27. The processing circuit 21, the storage circuit 22, the communication circuit 24, the input device 26, and the projection device 27 are coupled to one another by a bus 29 for communicating information.

The processing circuit 21 is a computer such as a CPU. The processing circuit 21 may be configured by one or a plurality of processors.

The storage circuit 22 is configured by a magnetic storage device, a flash ROM, or the like. The storage circuit 22 is a recording medium readable by the processing circuit 21 and stores a plurality of programs including a control program PR2 and a communication control program PRM, various information to be used by the processing circuit 21, and the like. The control program PR2 is a system program including an OS of the projector 20. The communication control program PRM is a program for controlling an operation of the projector 20 in the display system 1.

The communication circuit 24 is hardware including a communication circuit for performing wireless communication with another device such as the PC 10. The communication circuit 24 is also described as, for example, network device, network controller, network card, or communication module.

The input device 26 is equipment for the presenter U to input information. The input device 26 is a plurality of buttons including, for example, a function list display key, an up key, a down key, a left key, a right key, an enter key, and a cancel key. Alternatively, the input device 26 may be configured by one or more types of devices such as a pointing device and a touch panel. Alternatively, the projector 20 may communicate with, instead of the input device 26, a remote controller including the plurality of buttons explained above.

The projection device 27 is a device that projects the image GC onto the projection region PR based on image data transmitted from the processing circuit 21. The projection device 27 includes a light source 27a, a display panel 27b, and an optical system 27c.

The light source 27a includes a light source such as a halogen lamp, a xenon lamp, an ultra-high pressure mercury lamp, an LED, or a laser light source and emits red, green, and blue light. LED is an abbreviation of Light Emitting Diode. The display panel 27b is a light modulator including three light modulation elements provided to correspond to red, green, and blue. The light modulation elements include, for example, transmissive liquid crystal panels, reflective liquid crystal panels, or digital mirror devices and modulate lights of colors corresponding thereto to thereby generate image lights of the colors. The image lights of the colors generated by the display panel 27b are combined together by a color combination optical system to be full color image light. The optical system 27c is a projection optical system including, for example, a projection lens that projects the full color image light from the display panel 27b onto the projection region PR to form the image GC.

FIG. 1 is referred to gain. In the example illustrated in FIG. 1, the projector 20 communicates with the PC 10_1 and an image GP_1 displayed on a display 17_1 and the image GC projected onto the projection region PR are the same.

In the present specification, the image GP and the image GC being the same means that the image data transmitted to the display 17 by the processing circuit 11 and the image data transmitted to the projection device 27 by the processing circuit 21 are the same. Therefore, even if the color reproducibility of the display 17 and the color reproducibility of the projection device 27 are different, if the image data transmitted to the display 17 by the processing circuit 11 and the image data transmitted to the projection device 27 by the processing circuit 21 are the same, the image GP and the image GC are regarded as the same.

### 1-2. In the Progress of an Event

During the progress of an event, connection between the PC 10_1 and the projector 20 and connection between the PC 10_2 and the projector 20 are established and, while the presenter U_1 or a presenter U_2 is explaining the image GC, a presenter U_3 who makes presentation next to the presenter U_2 requests to proceed with preparation for projection onto the projector 20. An example of the preparation for the projection is to establish connection between a PC 10_3 and the projector 20. The establishment of the connection means setting a logical communication path before starting data transfer. More specifically, the establishment of the connection means that the PC 10 logs in to a service in which the projector 20 projects an image. Alternatively, the establishment of the connection may be performing three-way handshake when TCP is used in the communication between the PC 10 and the projector 20. TCP is an abbreviation of Transmission Control Protocol. By the connection being established, the PC 10 can access the projector 20 and the presenter U can prepare for projection. In the following description, establishing the connection between the PC 10 and the projector 20 is sometimes described as “the PC 10 logs in to the projector 20”.

In general, a time when the presenter U can give an explanation is allocated in advance. When a problem in that the PC 10_3 cannot log in to the projector 20 occurs, if it takes time to solve the problem, it is likely that time when the presenter U_3 can give an explanation decreases. Therefore, the PC 10_3 logs in to the projector 20 while the presenter U_1 or the presenter U_2 is explaining the image GC, whereby the presenter U_3 can proceed with the explanation without delay after the explanation of the presenter U_2 ends.

A method of the PC 10 logging in to the projector 20 is as follows. The projector 20 displays an image including an identification code in the projection region PR in response to predetermined operation such as power-on. The presenter U inputs the identification code displayed in the projection region PR to the PC 10, whereby the PC 10 logs in to the projector 20.

A situation is conceivable in which, in order for the PC 10_3 to log in to the projector 20, the PC 10_3 requests the projector 20 to authorize connection to the projector 20 while the presenter U_1 or the presenter U_2 is explaining the image GP. In this situation, if the projector 20 displays the image including the identification code in the projection region PR, there is a problem in that the display of the image GP based on the image data transmitted from the PC 10_1 or the PC 10_2 is hindered. When the display of the image GP based on the image data transmitted from PC 10_1 or PC 10_2 is hindered, the presenter U_1 or the presenter U_2 cannot proceed with the explanation concerning the image GP. Further, the presenter U_1 or the presenter U_2 needs to explain to the spectators W that the image including the identification code is irrelevant to the content explained by the presenter U_1 or the presenter U_2.

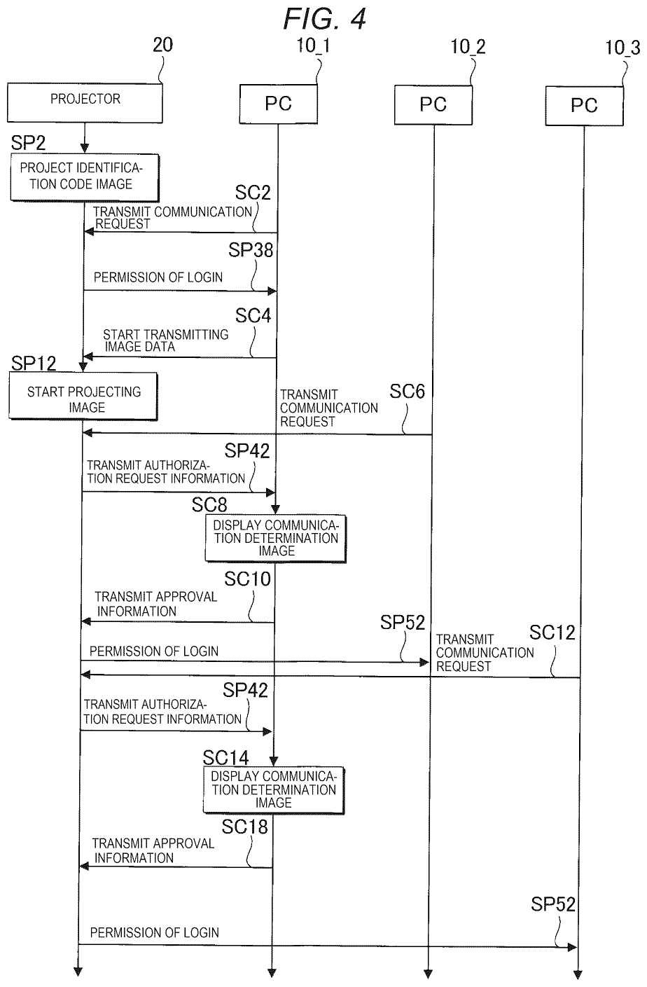

Thus, in the display system 1 in the present embodiment, management authority for managing authorization of communication with the projector 20 is set in the PC 10_1. When authorization of communication between the PC 10_3 and the projector 20 is requested from the PC 10_3, the display system 1 notifies, to the PC 10_1 in which the management authority is set, that the authorization of the communication is requested. In the following description, the request for authorization of communication is sometimes described as “communication request”. The PC 10_1 outputs, to the display 17 of the PC 10_1, information for causing the presenter U_1 to determine whether to approve the authorization of the communication. The information for causing the presenter U_1 to determine whether to approve the authorization of the communication between the PC 10_3 and the projector 20 may be a character string indicating whether to approve the authorization of the communication between the PC 10_3 and the projector 20 or may be image data indicating an image. In the following description, the information for causing the presenter U_1 to determine whether to approve the authorization of the communication between the PC 10_3 and the projector 20 is image data and is sometimes described as “communication determination image data”. When the projector 20 receives, from the PC 10_1, information indicating that the authorization of the communication between the PC 10_3 and the projector 20 has been approved, the PC 10_3 logs in to the projector 20. Since the image indicated by the communication determination image data is not displayed in the projection region PR, the presenter U_1 can proceed with the explanation concerning the image GP without delay. An operation of the display system 1 is explained with reference to FIGS. 4, 5, and 6.

### 1-3. Operation of the Display System 1

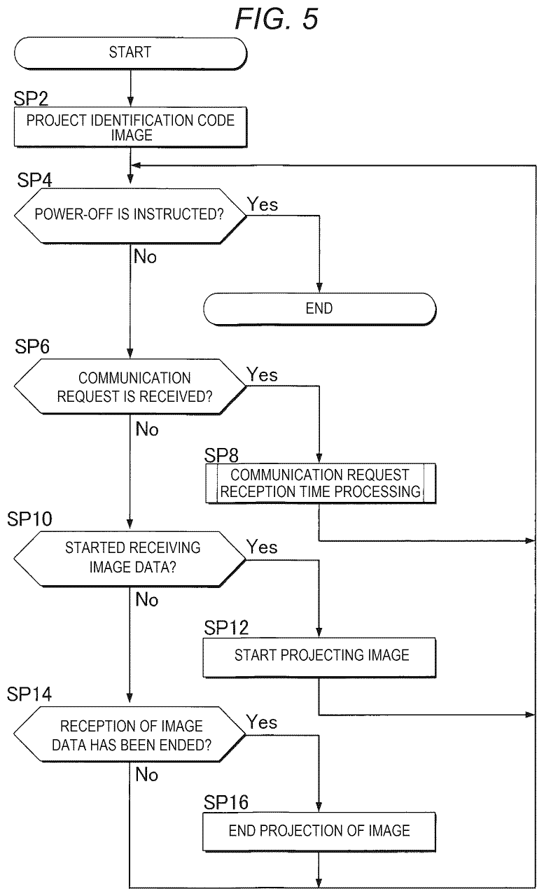

FIG. 4 is a sequence diagram illustrating an example of the operation of the display system 1. FIG. 5 is a flowchart illustrating an example of an operation of the projector 20. In FIG. 4, explanation is based on a premise that the PCs 10 provided in the display system 1 are the PC 10_1, the PC 10_2, and the PC 10_3. In the first embodiment, management authority for the projector 20 is set in the PC 10_1 that has logged in to the projector 20 first. Then, the projector 20 causes the presenter U at the PC 10, in which the management authority is set, to determine whether to approve authorization of communication with the projector 20. In the following description, the PC 10 in which the management authority is set is sometimes described as “management authority PC 10_m”. Among the three or more PCs 10 provided in the display system 1, there is only one management authority PC 10_m. The management authority PC 10_m is an example of a “management device”.

In the following description, the number of the plurality of PCs 10 of the display system 1 is three or more. The PC 10_1 is equivalent to a “first communication terminal”, the PC 10_2 is equivalent to a “second communication terminal”, and the PC 10_3 is equivalent to a “third communication terminal”. Communication between the PC 10_1 and the projector 20 is equivalent to “first communication”. Communication between the PC 10_2 and the projector 20 is equivalent to “second communication”. Communication between the PC 10_3 and the projector 20 is equivalent to “third communication”. The presenter U_1 is equivalent to a “user of the first communication terminal”.

The processing circuit 21 of the projector 20 executes the operations illustrated in FIGS. 4 and 5 by reading the communication control program PRM from the storage circuit 22 and executing the read communication control program PRM. The processing circuit 11 of the PC 10 executes the operation illustrated in FIG. 4 by reading the projector communication control program PRJ from the storage circuit 12 and executing the read projector communication control program PRJ.

As illustrated in FIGS. 4 and 5, in step SP2, the processing circuit 21 projects an identification code image including an identification code onto the projection region PR after power-on. The identification code is, for example, a character string having a plurality of alphanumeric characters. Then, as illustrated in FIG. 5, in step SP4, the processing circuit 21 determines whether power-off is instructed by, for example, pressing a power button of the projector 20. When a determination result in step SP4 is affirmative, the processing circuit 21 ends a series of processing illustrated in FIG. 5.

When the determination result in step SP4 is negative, as illustrated in FIG. 5, in step SP6, the processing circuit 21 determines whether a communication request is received from the PC 10. When a determination result in step SP6 is affirmative, as illustrated in FIG. 5, the processing circuit 21 executes communication request reception time processing in step SP8.

In FIG. 4, explanation is based on a premise that the PC 10_1 has transmitted a communication request including an identification code to the projector 20 in step SC2 according to input operation of the presenter U_1 after the processing circuit 21 ended the processing in step SP2.

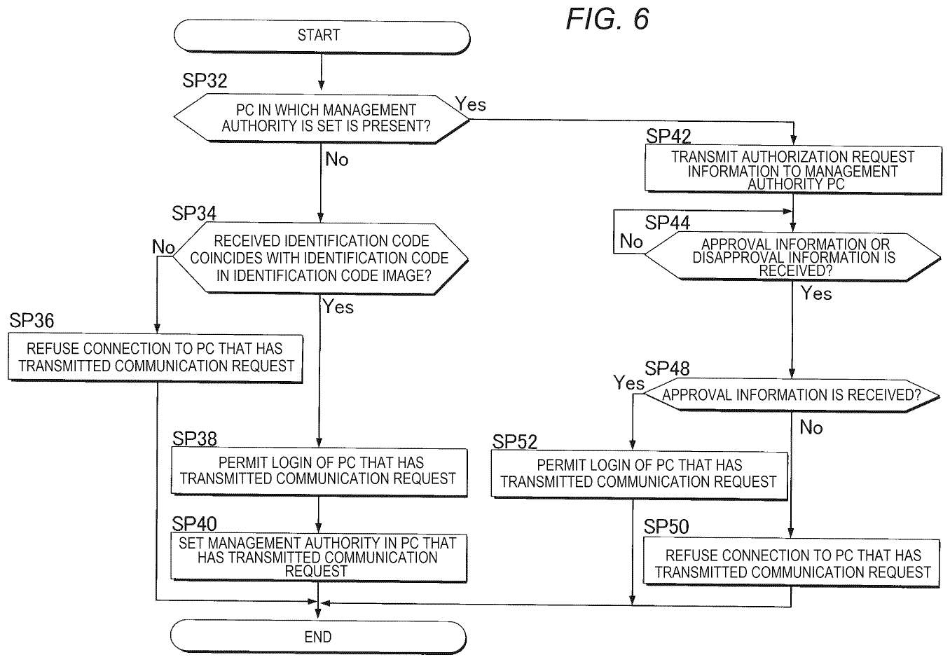

When receiving a communication request from the PC 10_1, which is the first the PC 10, the processing circuit 21 determines that the determination result in step SP6 is affirmative and executes the communication request reception time processing in step SP8. The communication request reception time processing is explained with reference to FIG. 6.

FIG. 6 is a flowchart illustrating an example of the communication request reception time processing. In step SP32, the processing circuit 21 determines whether the PC 10 in which the management authority is set is present.

In the example illustrated in FIG. 4, the PC 10 in which the management authority is set is absent at the stage of step SC2. Therefore, the processing circuit 21 determines that a determination result in step SP32 is negative. When the determination result in step SP32 is negative, as illustrated in FIG. 6, in step SP34, the processing circuit 21 determines whether the received identification code coincides the identification code included in the identification code image. When a determination result in step SP34 is negative, in step SP36, the processing circuit 21 refuses the connection to the PC 10 that has transmitted the communication request and ends a series of processing illustrated in FIG. 6. Under the instruction of the processing circuit 21, as an example of the refusal of the connection to the PC 10, the communication circuit 24 transmits a refusal response to the PC 10 that has transmitted the communication request. The refusal response includes, for example, an identifier indicating that the identification code input by the user is wrong.

When the determination result in step SP34 is affirmative, as illustrated in FIGS. 4 and 6, in step SP38, the processing circuit 21 gives permission for login to the PC 10_1, which is the PC 10 that has transmitted the communication request, and the PC 10_1 logs in to the projector 20. Subsequently, as illustrated in FIG. 6, in step SP40, the processing circuit 21 sets the management authority in the PC 10 that has transmitted the communication request and ends the series of processing illustrated in FIG. 6.

FIGS. 4 and 5 are referred to again. After the processing in step SP8 ends, the processing circuit 21 executes the processing in step SP4 again.

When the determination result in step SP6 is negative, as illustrated in FIG. 5, in step SP10, the processing circuit 21 determines whether reception of image data is started from the PC 10 that has logged in to the projector 20.

In the example illustrated in FIG. 4, in step SC4, the PC 10_1 that has logged in to the projector 20 starts transmitting image data to the projector 20. In the example illustrated in FIG. 4, the processing circuit 21 determines that a determination result in step SP10 is affirmative. When the determination result in step SP10 is affirmative, as illustrated in FIGS. 4 and 5, in step SP12, based on an instruction of the processing circuit 21, the projection device 27 starts projecting an image based on the received image data. The image based on the image data may be the image itself indicated by the image data, may be a partial image of the image indicated by the image data, or may be an image obtained by superimposing another image on the image indicated by the image data or the partial image of the image. The other image is, for example, a character string indicating the present time or an OSD image in which the position and the contrast of the image can be operated. OLD is an abbreviation of On Screen Display.

In step SP12, when image data is received from two or more PCs 10, the projection device 27 projects an image based on the image data received from each of the two or more PCs 10 onto regions obtained by dividing the projection region PR. After the processing in step SP12 ends, the processing circuit 21 executes the processing in step SP4 again.

When the determination result in step SP10 is negative, as illustrated in FIG. 5, in step SP14, the processing circuit 21 determines whether the reception of the image data has been ended. When a determination result in step SP14 is affirmative, as illustrated in FIG. 5, in step SP16, based on an instruction of the processing circuit 21, the projection device 27 ends the projection of the image based on the received image data.

In step SP16, when the image data is received from three or more PCs 10 and the reception of the image data from one Pc 10 is ended, the projection device 27 reduces the number of divisions of the projection region PR and then projects an image based on the image data received from each of the two or more PCs 10. When the image data is received from two PCs 10 and the reception of the image data from one Pc 10 is ended, the projection device 27 releases the division of the projection region PR and projects an image based on the image data received from the remaining one PC 10.

After the processing in step SP16 ends, the processing circuit 21 executes the processing in step SP4 again. When the determination result in step SP14 is negative, the processing circuit 21 also executes the processing in step SP4 again.

In FIG. 4, explanation is based on a premise that, after the projection device 27 started projecting an image in step SP12, in step SC6, the PC 10_2 has transmitted, to the projector 20, a communication request to the projector 20. Therefore, the processing circuit 21 determines that the determination result in step SP6 is affirmative and further determines that the determination result in step SP32 is affirmative because there is one PC 10 in which the management authority is set in step SP32 in FIG. 6.

FIGS. 4 and 6 are referred to again. When the determination result in step SP32 is affirmative, in step SP42, the communication circuit 24 transmits authorization request information to the management authority PC 10_m, in the example illustrated in FIG. 4, the PC 10_1, under an instruction of the processing circuit 21. The authorization request information is information indicating that the PC 10 has been requested to authorize communication with the projector 20 and is information necessary for causing the presenter U to determine whether the PC 10 approves the authorization of the communication with the projector 20. The authorization request information is, for example, information concerning the PC 10 that has transmitted the communication request to the projector 20. For example, the authorization request information includes a name of the PC 10 that has requested permission of communication and an account ID of an account logging in to the PC 10. ID is an abbreviation of Identification.

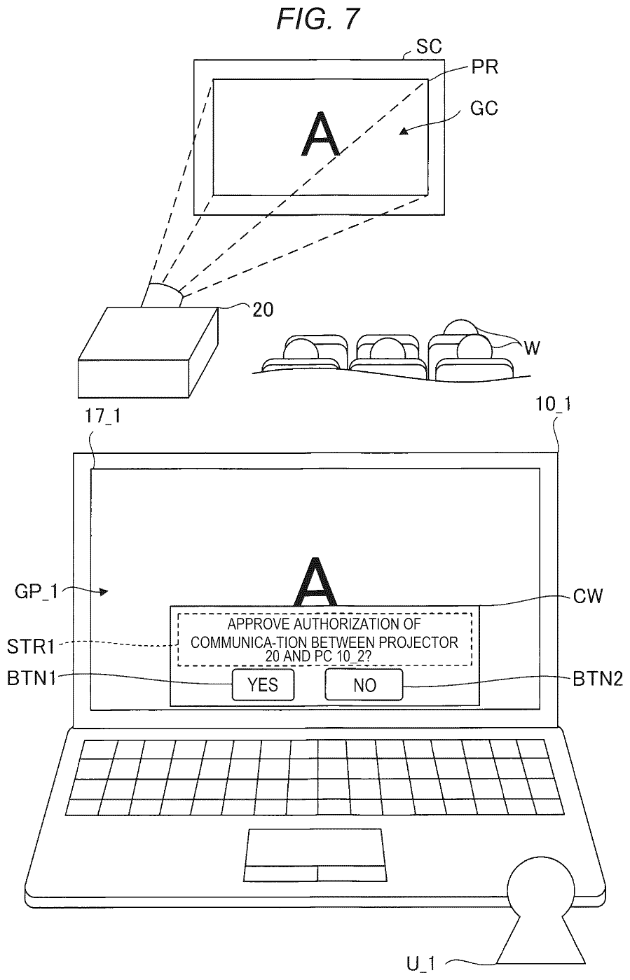

The processing circuit 11 of PC 10 that has received the authorization request information, in the example illustrated in FIG. 4, the PC 10_1, generates communication determination image data based on the authorization request information as illustrated in FIG. 4 and, in step SC8, causes the display 17 to display a communication determination image CW indicated by the communication determination image data. A display example of the communication determination image CW is explained with reference to FIG. 7.

FIG. 7 is a diagram illustrating an example of the communication determination image CW. As illustrated in FIG. 7, the display 17 superimposes the communication determination image CW on the image GP_1. In the example illustrated in FIG. 7, the communication determination image CW includes a character string STR1, a button BTN1, and a button BTN2. The character string STR1 is “approve authorization of communication between the projector 20 and the PC 10_2?”. The button BTN1 is a button for, by being pressed by the presenter U, transmitting, to the projector 20, approval information indicating that the authorization of the communication with the projector 20 has been approved. The button BTN2 is a button for transmitting, to the projector 20, disapproval information indicating that the authorization of the communication with the projector 20 has been disapproved.

As illustrated in FIG. 7, the communication determination image CW is displayed on the display 17_1, but is not projected onto the projection region PR.

FIGS. 4 and 6 are referred to again. After the processing in step SP42 ends, as illustrated in FIG. 6, in step SP44, the processing circuit 21 determines whether the approval information or the disapproval information is received from the management authority PC 10_m. When a determination result in step SP44 is negative, the processing circuit 21 executes the processing in step SP44 again. In the example illustrated in FIG. 4, explanation is based on a premise that the button BTN1 is pressed by operation of the presenter U_1 and the PC 10_1 transmits the approval information to the projector 20 in step SC10. Therefore, the processing circuit 21 determines that the determination result in step SP44 is affirmative.

When the determination result in step SP44 is affirmative, in step SP48, the processing circuit 21 determines whether the approval information is received. When the determination result in step SP48 is affirmative, in step SP52, the processing circuit 21 gives login permission to the PC 10 that has transmitted the communication request. The PC 10 that has transmitted the communication request logs in to the projector 20. The processing in step SP52 is the same as the processing in step SP38. In the example illustrated in FIG. 4, the processing circuit 21 gives the login permission to the PC 10_2. After the processing in step SP52 ends, the processing circuit 21 ends processing illustrated in FIG. 6.

When the determination result in step SP48 is negative, that is, when the disapproval information is received, as illustrated in FIG. 6, in step SP50, the processing circuit 21 refuses the connection to the PC 10 that has transmitted the communication request and ends the series of processing illustrated in FIG. 6. The processing in step SP50 is the same as the processing in step SP36. However, content of a refusal response in step SP50 may be different from the content of the refusal response in step SP36. The refusal response in step SP50 includes, for example, an identifier indicating that authorization of communication is disapproved by the user of the PC 10 having the management authority of the projector 20.

In the example illustrated in FIG. 4, explanation is based on a premise that, after the processing circuit 21 executed the processing in step SP38 and the PC 10_2 logged in to the projector 20, the PC 10_3 has transmitted a communication request to the projector 20 in step SC12.

When receiving the communication request, the processing circuit 21 determines that the determination results in step SP6 and step SP32 are affirmative. Then, in step SP42, the communication circuit 24 transmits communication determination information to the management authority PC 10_m, in the example illustrated in FIG. 4, the PC 10_1, under an instruction of the processing circuit 21. In step SC14, the PC 10_1 causes the display 17_1 to display the communication determination image CW. The communication determination image CW displayed on the display 17_1 is an image for causing the presenter U_1 to determine whether to approve authorization of communication between the PC 10_3 and the projector 20.

In the example illustrated in FIG. 4, explanation is based on a premise that the processing circuit 11_1 of the PC 10_1 has transmitted the approval information to the projector 20 in step SC18 based on operation of the presenter U_1. When the projector 20 receives the approval information, as illustrated in FIG. 4, in step SP52, the processing circuit 21 gives login permission to the PC 10_3, which is the PC 10 that has transmitted the communication request, and the PC 10_3 logs in to the projector 20.

### 1-4. Summary of the First Embodiment

In the following description, a summary of the first embodiment is explained with communication between the PC 10_1 and the projector 20 described as first communication, communication between the PC 10_2 and the projector 20 described as second communication, and communication between the PC 10_3 and the projector 20 described as third communication.

The display system 1 according to the first embodiment is the display system 1 including the three or more PCs 10 and the projector 20 capable of communicating with the three or more PCs 10. Further, the display system 1 executes a method of controlling communication with the projector 20. In step SP 38, the projector 20 capable of projecting an image onto the projection region PR establishes the first communication with the PC 10_1 in which the management authority for managing the authorization of the communication with the projector 20 is set among the three or more PCs 10 and establishes the second communication with the PC 10_2 among the three or more PCs 10 in step SP 52. When authorization of the third communication is requested from PC 10_3 among the three or more PCs 10 while an image is projected onto the projection region PR, in step SP42, the projector 20 transmits, to the management authority PC 10_m, which is the PC 10 in which the management authority is set, the communication determination information indicating that the authorization of the third communication has been requested. The management authority PC 10_m outputs the communication determination image data, which is the information for causing the user of the management authority PC 10_m to determine whether to approve the authorization of the third communication, to the display 17_1 of the management authority PC 10_m. The display 17_1 is an example of the output destination of the information for causing the presenter U_1 to determine whether to approve the authorization of the third communication. When receiving, from the management authority PC 10_m, the approval information indicating that the authorization of the third communication has been approved, the projector 20 establishes the third communication.

According to the first embodiment, the communication determination image CW indicated by the communication determination image data is displayed on the display 17_1 but is not projected onto the projection region PR. Therefore, the projection of the image GP_1 based on the image data transmitted from the PC 10_1 is not hindered. Further, the PC 10_3 can establish communication with the projector 20. Therefore, according to the first embodiment, the PC 10_3 can establish the communication with the projector 20 while preventing the display of the image based on the image data transmitted from the PC 10_1 or the PC 10_2 from being hindered.

### 2. Second Embodiment

A second embodiment is different from the first embodiment in that the management authority is moved to another PC 10 when there is no response from the management authority PC 10_m. The second embodiment is explained below.

### 2-1. Operation in the Second Embodiment

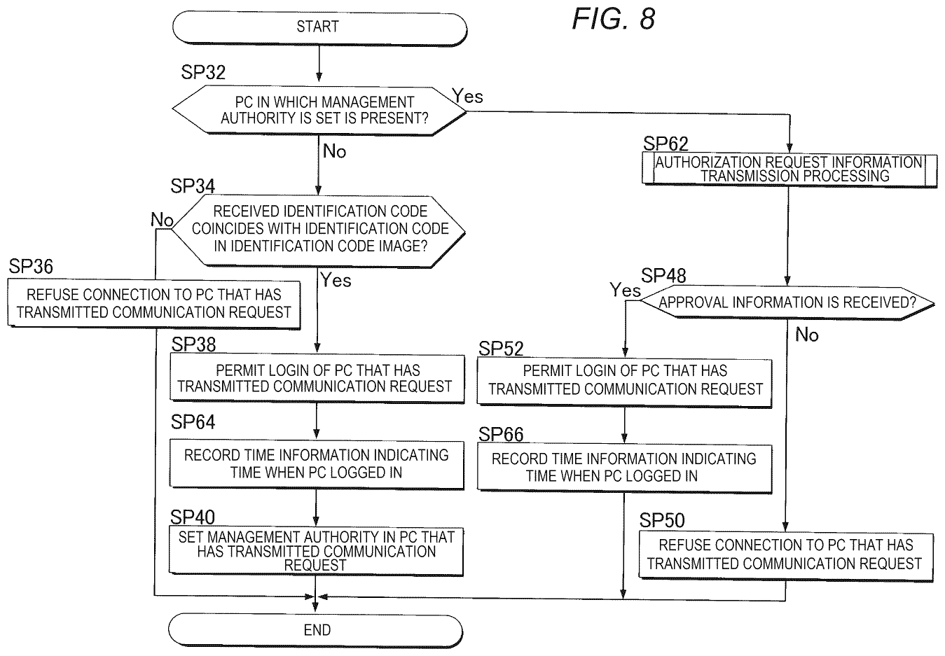

FIG. 8 is a flowchart illustrating an example of communication request reception time processing in the second embodiment. The flowchart illustrated in FIG. 8 is different from the flowchart illustrated in FIG. 6 in that processing in step SP62 is executed instead of the processing in SP42 and the processing in step SP44, the processing in step SP62 is executed after execution of the processing in step SP38, the processing in step SP64 is executed after the execution of the processing in step SP38, and processing in step SP66 is executed after execution of the processing in step SP52 and is the same as the flowchart illustrated in FIG. 6 in other parts. In the following explanation, only the difference from the flowchart illustrated in FIG. 8 is explained.

After the processing in step SP38 ends, in step SP64, the processing circuit 21 records, in the storage circuit 22, time information indicating time when the PC 10, which logged in in step SP38, logged in. The time information is, for example, a character string indicating time. Specifically, in step SP64, the processing circuit 21 records, in the storage circuit 22, in association with identification information of the PC 10 that logged in in step SP38, time information indicating the present time as the time information indicating the time when the PC 10 logged in. The identification information of the PC 10 is, for example, one or more of a name of the PC 10, a serial number of the PC 10, an MAC address of the PC 10, and an IP address of the PC 10. MAC is an abbreviation of Media Access Control. IP is an abbreviation of Internet Protocol. After the processing in step SP64 ends, the processing circuit 21 executes the processing in step SP40.

After the processing in step SP52 ends, in step SP66, the processing circuit 21 records, in the storage circuit 22, the time when the PC 10, which logged in in step SP52, logged in. The processing in step SP66 is the same as the processing in step SP64.

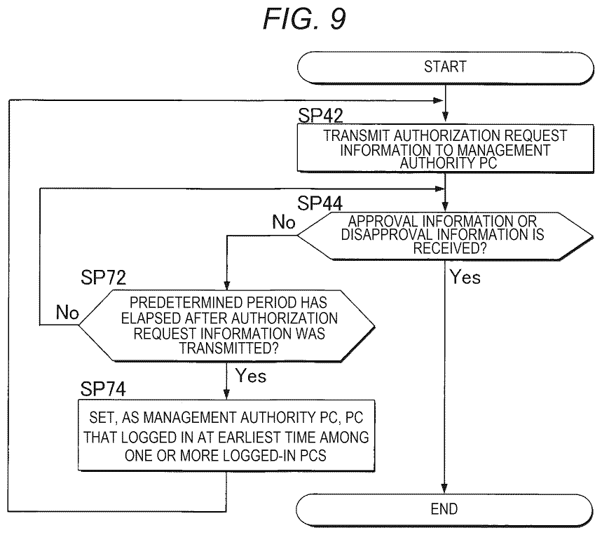

When a determination result in step SP32 is affirmative, the processing circuit 21 executes authorization request information transmission processing in step SP62. The authorization request information transmission processing is explained with reference to FIG. 9.

FIG. 9 is a flowchart illustrating an example of the authorization request information transmission processing. In the flowchart illustrated in FIG. 9, processing in step SP42 and processing in step SP44 are respectively the same as the processing in step SP42 and the processing in step SP44 of the flowchart illustrated in FIG. 6. Therefore, explanation of the processing is omitted. In the following explanation, when step numbers are the same as the step numbers of the steps already explained, steps indicated by the step numbers are assumed to have already been explained and explanation of the steps is omitted.

The processing circuit 21 executes the processing in step SP42 and executes the processing in step SP44. When a determination result in step SP44 is affirmative, the processing circuit 21 ends a series of processing illustrated in FIG. 9.

When the determination result in step SP44 is negative, in step SP72, the processing circuit 21 determines whether a predetermined period has elapsed after the authorization request information was transmitted. The predetermined period may be any time length. For example, the predetermined period is one minute. When a determination result in step SP72 is negative, the processing circuit 21 executes the processing in step SP44 again.

When the determination result in step SP72 is affirmative, in step SP74, the processing circuit 21 sets, as the management authority PC 10_m, the PC 10 that logged in at the earliest time among one or more PCs 10 that logged in to the projector 20. For example, when two PCs 10 logged in to the projector 20, since one PC 10 is the management authority PC 10_m, the processing circuit 21 sets the other PC 10 as the management authority PC 10_m. In step SP74, the processing circuit 21 may set, as the management authority PC 10_m, the PC 10 that logged in at the earliest time from the PCs 10 excluding the PC 10 that disconnected communication with the projector 20 among the one or more PCs 10 that logged in to the projector 20. The PC 10 that disconnected the communication with the projector 20 is, in other words, the PC 10 that logged out from the projector 20. For example, the processing circuit 21 deletes, from the storage circuit 22, time information associated with identification information of the logged-out PC 10.

After the processing in step SP74 ends, the processing circuit 21 executes the processing in step SP42. Therefore, the projector 20 switches the management authority PC 10_m every time the predetermined period elapses. After the processing in step SP74 ends, the processing circuit 21 may instruct the PC 10 set as the management authority PC 10_m to display a dialogue indicating that “the management authority has been set”.

### 2-2. Summary of the Second Embodiment

In the following description, communication between the PC 10_1 and the projector 20 is referred to as first communication, communication between the PC 10_2 and the projector 20 is referred to as second communication, and communication between the PC 10_3 and the projector 20 is referred to as third communication. Further, a summary of the second embodiment is explained using a state in which the PCs 10 that logged in to the projector 20 are the PC 10_1 and the PC 10_2 and the PC 10_1 is set as the management authority PC 10_m.

The projector 20 sets management authority in the PC 10_2 when a predetermined period has elapsed without the projector 20 receiving approval information or disapproval information after the projector 20 transmitted the authorization request information to the PC 10_1, which is the management authority PC 10_m.

According to the second embodiment, when the presenter U_1 at the PC 10_1 overlooks the communication determination image CW or when the presenter U_1 cannot operate PC 10_1 because the presenter U_1 is busy because of a reason such as talking on his/her mobile phone or the like, another presenter U can temporarily determine whether to approve authorization of communication between the PC 10_3 and the projector 20.

### 3. Modifications

The embodiments exemplified above can be variously modified. Specific aspects of modifications applicable to the embodiments explained above are exemplified below. Two or more aspects optionally selected from the following exemplifications can be combined as appropriate to the extent that no contradiction occurs among the aspects.

### 3-1. First Modification

A first modification is different from the second embodiment in that, when the projector 20 receives a logout instruction from the management authority PC 10_m, the projector 20 causes the presenter U at the management authority PC 10_m to select the next management authority PC 10_m out of one or more PCs 10 logging in to the projector 20. The first modification is explained below.

### 3-1-1. Operation in the First Modification

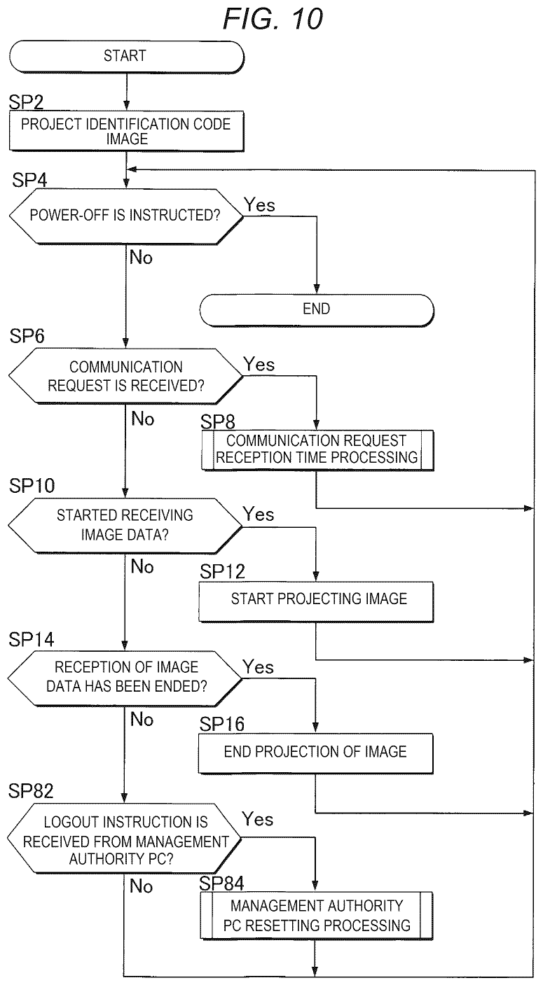

FIG. 10 is a flowchart illustrating an example of an operation of the projector 20 in the first modification. The flowchart i illustrated in FIG. 10 is different from the flowchart illustrated in FIG. 5 in that processing in step SP82 is executed when the determination result in step SP14 is negative and is the same as the flowchart illustrated in FIG. 5 in other parts. Only the difference from the flowchart illustrated in FIG. 5 is explained.

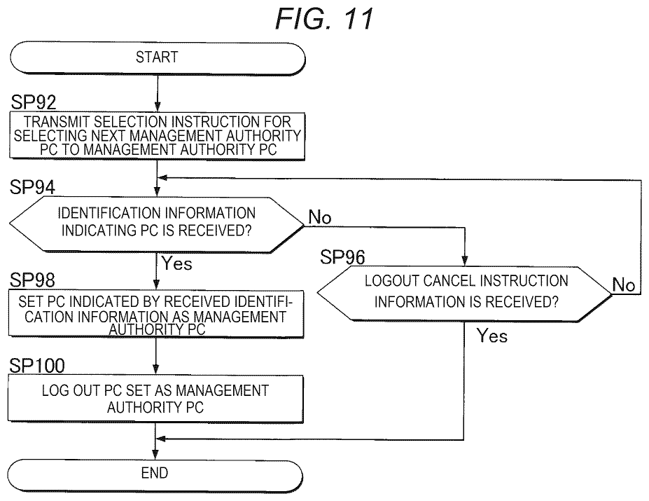

When the determination result in step SP14 is negative, in step SP82, the processing circuit 21 determines whether a logout instruction is received from the management authority PC 10_m. When a determination result in step SP82 is negative, the processing circuit 21 executes the processing in step SP4 again. When the determination result in step SP82 is affirmative, the processing circuit 21 executes management authority PC resetting processing in step SP84. The management authority PC resetting processing is explained with reference to FIG. 11.

FIG. 11 is a flowchart illustrating an example of management authority PC resetting processing. The management authority PC resetting processing is processing of setting, before the management authority PC 10_m logs out from the projector 20, based on an operation result of the input unit 16 of the presenter U at the management authority PC 10_m, the next management authority PC 10_m from the PCs 10 other than the management authority PC 10_m among the one or more PCs 10 logging in to the projector 20.

In step SP92, the communication circuit 24 transmits a selection instruction for selecting the next management authority PC 10_m to the management authority PC 10_m under an instruction of the processing circuit 21. The selection instruction includes a list of identification information of the PCs 10 stored in the storage circuit 22 by the execution of the processing in step SP64 and the processing in step SP66.

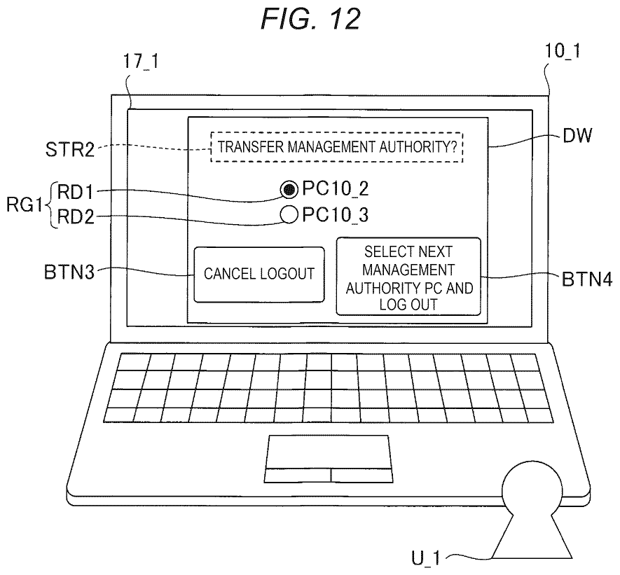

When the selection instruction is received, the management authority PC 10_m generates, based on the selection instruction, image data indicating the selection instruction image DW and displays the selection instruction image DW on the display 17. The selection instruction image DW is explained with reference to FIG. 12.

FIG. 12 is a diagram illustrating an example of the selection instruction image DW. The example illustrated in FIG. 12 is based on a premise that one or more PCs 10 logging in to the projector 20 are the PC 10_1, the PC 10_2, and the PC 10_3 and the management authority PC 10_m is the PC 10_1.

In the example illustrated in FIG. 12, the selection instruction image DW includes a character string STR2, a radio button group RG1, a button BTN3, and a button BTN4. The character string STR2 is “Transfer management authority?”. The radio button group RG1 includes radio buttons RD associated with identification information of the PCs 10 included in the selection instruction. Therefore, the radio button group RG1 illustrated in FIG. 12 includes a radio button RD1 associated with identification information of the PC 10_2 and a radio button RD2 associated with identification information of the PC 10_3. When one radio button of the radio buttons RD1 and RD2 is selected, selection of the other radio button is released.

The button BTN3 is a button for cancelling logout. A character string “Cancel logout” is displayed on the button BTN3. The button BTN4 is a button for selecting, as the next management authority PC 10_m, the PC 10 indicated by, of the radio buttons RD1 and RD2, the radio button RD selected by the management authority PC 10_m and logging out. A character string “Select the next management authority PC and log out” is displayed on the button BTN4.

When the button BTN3 is pressed, the management authority PC 10_m transmits cancellation instruction information indicating a logout cancellation instruction to the projector 20. When the button BTN4 is pressed, the management authority PC 10_m transmits, to the projector 20, the identification information of the PC 10 associated with the radio button RD selected by the presenter U at the management authority PC 10_m. The PC 10 indicated by the identification information transmitted to the projector 20 is the PC 10 specified based on an operation result of the input unit 16 of the PC 10 by the presenter U at the management authority PC 10_m logging in to the projector 20.

FIG. 11 is referred to again. After the processing in step SP92 ends, in step SP94, the processing circuit 21 determines whether the identification information of PC 10 is received from the projector 20. If a determination result in step SP94 is negative, in step SP96, the processing circuit 21 determines whether logout cancellation instruction information is received. If a determination result in step SP96 is negative, the processing circuit 21 executes the processing in step SP94 again.

When the determination result in step SP94 is affirmative, in step SP98, the processing circuit 21 sets the PC 10 indicated by the received identification information as the management authority PC 10_m. After the processing in step SP98 ends, in step SP100, the processing circuit 21 logs out the PC 10 set as the management authority PC 10_m. After the processing in step SP100 ends, the processing circuit 21 ends the series of processing illustrated in FIG. 11. When the determination result in step SP96 is affirmative, the processing circuit 21 also ends the series of processing illustrated in FIG. 11. As understood from FIG. 11, when the determination result in step SP96 is affirmative, since the processing circuit 21 does not execute step SP100, the logout of the management authority PC 10_m is canceled.

In the flowchart illustrated in FIG. 11, the projector 20 sets the next management authority PC 10_m based on the operation result of the input unit 16 of the presenter U at the management authority PC 10_m in steps SP92, SP94, and SP96. However, a method of setting the next management authority PC 10_m is not limited to this. For example, the projector 20 may set, from the PCs 10 other than the management authority PC 10_m among the one or more PCs 10 logging in to the projector 20, as the next management authority PC 10_m, the PC 10 having the highest intensity of a reception signal received by the communication circuit 24. Alternatively, as in the second embodiment, the projector 20 may set, from the PCs 10 other than the management authority PC 10_m among the one or more PCs 10 logging in to the projector 20, as the next management authority PC 10_m, the PC 10 that logged in to the projector 20 at the earliest time. In an aspect in which the next management authority PC 10_m is set based on the intensity of a reception signal, the projector 20 and each of the N PCs 10 need to be directly connected by wireless communication not via relay equipment.

Further, the aspect in which the next management authority PC 10_m is set based on the intensity of a reception signal and an aspect in which the next management authority PC 10_m is set based on time of login to the projector 20 can also be applied to the second embodiment. Specifically, when the determination result in step SP72 in FIG. 9 is affirmative, instead of the processing in step SP74, the processing circuit 21 may set, as the management authority PC 10_m, the PC 10 having the highest intensity of a reception signal received by the communication circuit 24. Alternatively, when the determination result in step SP72 in FIG. 9 is affirmative, instead of the processing in step SP74, the processing circuit 21 may set, as the management authority PC 10_m, the PC 10 that logged in to the projector 20 at the earliest time.

### 3-1-2. Summary of the First Modification

In the following description, communication between the PC 10_1 and the projector 20 is referred to as first communication, communication between the PC 10_2 and the projector 20 is referred to as second communication, and communication between the PC 10_3 and the projector 20 is referred to as third communication.

In a state in which the first communication and the second communication are established, when receiving an instruction to disconnect the first communication from the management authority PC 10_m, which is the PC 10_1, the projector 20 sets management authority in the PC 10_2. “When receiving an instruction to disconnect the first communication from the management authority PC 10 m” is an example of “in response to the first communication be disconnected”.

According to the first modification, when another PC 10 requests connection to the projector 20 after communication with the PC 10_1 in which management authority is set is disconnected, the presenter U_2 at the PC 10_2 can determine whether to approve the authorization of the communication between the PC 10_3 and the projector 20.

It is assumed that the three or more PCs 10 are four or more PCs 10, each of the four or more PCs 10 includes the input unit 16, and, in addition to the first communication and the second communication being established, fourth communication between a PC 10_4 among the four or more PCs 10 and the projector 20 is established. The PC 10_4 is an example of a “fourth communication terminal”. When receiving, from the PC 10_1, an instruction to disconnect the first communication, the projector 20 sets management authority in, of the PC 10_2 and the PC 10_4, the PC 10 specified based on an operation result of the input unit 16 of the PC 10_1 by the presenter U_1 at the PC 10_1 during the establishment of the first communication. For example, the projector 20 sets the management authority in the PC 10_2.

According to the first modification, when another PC 10 requests connection to the projector 20 after communication of the PC 10_1 in which management authority is set is disconnected, the presenter U at the PC 10_4 in which the management authority is set can determine whether to approve the authorization of the communication between the PC 10_3 and the projector 20. Among the N presenters U, the presenter U at the PC 10 set as the management authority PC 10_1 is most likely to be accustomed to operation of the management authority of the projector 20. For example, among the N presenters, the organizer who is the presenter U_1 in the first situation to which the display system 1 is applied and the teacher who is the presenter U_1 in the second situation to which the display system 1 is applied are most likely to be accustomed to the operation of the management authority of the projector 20. Therefore, in an aspect in which the management authority PC 10_m is set based on an operation result of the input unit 16 of the PC 10_1, the management authority can be set in the PC 10 of the presenter U admitted by the presenter U_1 who is most likely to be accustomed to the operation of the management authority of the projector 20.

It is assumed that the three or more PCs 10 are four or more PCs 10, each of the four or more PCs 10 and the projector 20 are capable of communicating with each other by wireless communication, and, in addition to the first communication and the second communication being established, the fourth communication between the PC 10_4 among the four or more PCs 10 and the projector 20 is established. When a predetermined period has elapsed without the projector 20 receiving both of approval information and disapproval information after the projector 20 transmitted authorization request information to the PC 10_1 or when receiving, from the PC 10_1, an instruction to disconnect the first communication, the projector 20 may set management authority in, of the PC 10_2 and the PC 10_4, the PC 10 having high intensity of a reception signal of wireless connection or the PC 10 that established communication with the projector 20 at early time.

According to the first modification, when the presenter U_1 at the PC 10_1 overlooks the communication determination image CW or when the presenter U_1 is busy and cannot operate PC 10_1, the presenter U at the PC 10_2 or the PC 10_4 can temporarily determine whether to approve the authorization of the communication between the PC 10_3 and the projector 20. Among the N presenters U, since the presenter U present closest to the projector 20 is highly likely to be accustomed to operation of the projector 20, such as directly operating the projector 20, the presenter U is also highly likely to be accustomed to operation of management authority of the projector 20. Therefore, in an aspect in which the PC 10 having high intensity of a reception signal of wireless connection is set as the management authority PC 10_m, the management authority can be set in the PC 10 of the presenter U who is highly likely to be accustomed to the operation of the management authority of the projector 20.

Among the N presenters U, the presenter U at the PC 10 that logged in to the projector 20 at early time is likely to have prepared for an event together with the presenter U_1. Therefore, the presenter U at the PC 10 that logged in to the projector 20 at early time is likely to be accustomed to the operation of the projector 20 and also accustomed to the operation of the management authority of the projector 20. Therefore, in an aspect in which the PC 10 that logged in to the projector 20 at early time is set as the management authority PC 10_m, the management authority can be set in the PC 10 of the presenter U who is likely to be accustomed to the operation of the management authority of the projector 20. In the aspect in which the management authority PC 10_m is set based on an operation result of the input unit 16 of the PC 10_1, even when the presenter U_1 needs to move to the next event, the presenter U_1 needs to select the next management authority PC 10_m, which is time-consuming. On the other hand, in the aspect in which the PC 10 having high intensity of a reception signal of wireless connection is set as the management authority PC 10_m and the aspect in which the PC 10 that logged in to the projector 20 at early time is set as the management authority PC 10_m, it is possible to reduce time consumed by the presenter U_1.

### 3-2. Second Modification

A second modification is different from the first embodiment, the second embodiment, and the first modification in that, when the PC 10 logged in to the projector 20 is in a mode of displaying an image in the projection region PR in an occupied manner, the PC 10 refuses the PC 10 logged in to the projector 20 anew to cause the projector 20 to display an image. The second modification is explained below.

### 3-2-1. Operation in the Second Modification

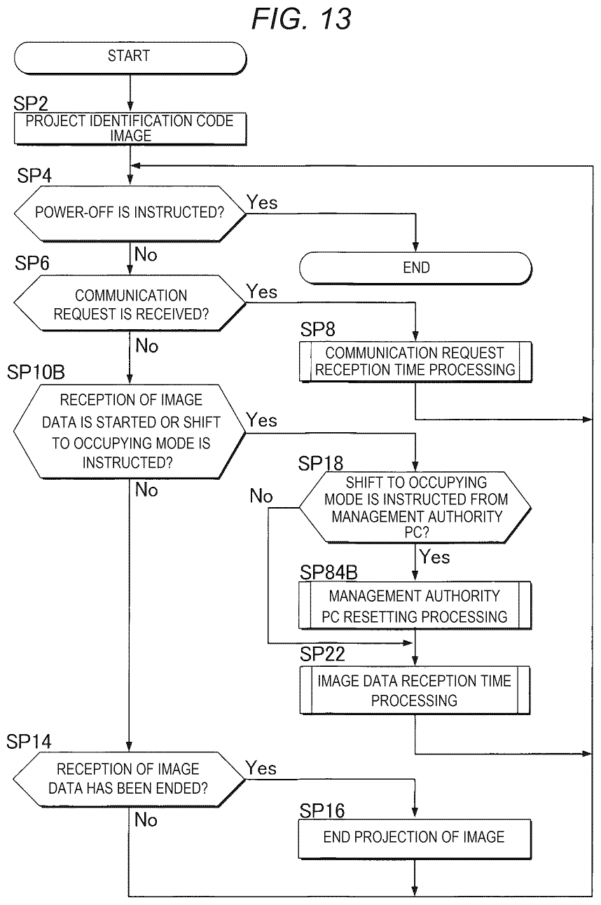

FIG. 13 is a flowchart illustrating an example of an operation of the projector 20 in the second modification. The flowchart illustrated in FIG. 13 is different from the flowchart illustrated in FIG. 5 in that processing in step SP10B is executed instead of the processing in step SP10 and in a series of processing in the case in which a determination result in step SP10B is affirmative and is the same as the flowchart illustrated in FIG. 5 in other parts. Only the difference from the flowchart illustrated in FIG. 5 is explained.

When the determination result in step SP6 is negative, in step SP10B, the processing circuit 21 determines whether reception of image data is started or whether a shift to an occupying mode is instructed by the presenter U at the PC 10. The occupying mode is a mode in which an image based on image data transmitted from one PC 10 among the three or more PCs 10 provided in the display system 1 is displayed in the projection region PR in an occupied manner. In the following description, the PC 10 in which the occupying mode is set is sometimes described as “occupying PC 10_o”. The display 17 of the occupying PC 10_o is sometimes described as “display 17_0”. Further, the presenter U at the occupying PC 10_o is sometimes described as presenter U_o. The occupying mode is an example of a “first mode”. The instruction to shift to the occupying mode is, for example, a “shift to occupying mode” button displayed on the display 17 of the PC 10 being pressed.

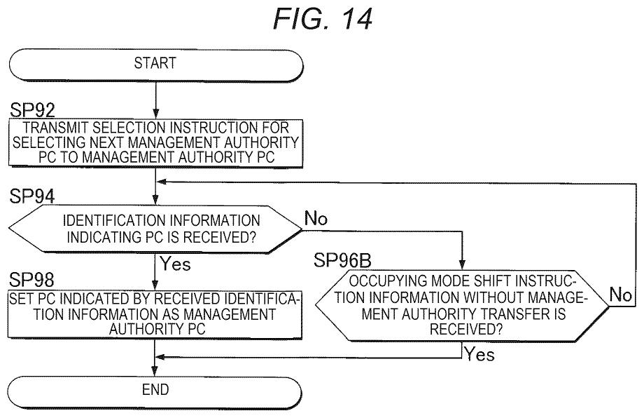

When a determination result in step SP10B is negative, the processing circuit 21 executes processing in step SP14. When the determination result in step SP10B is affirmative, in step SP18, the processing circuit 21 determines whether a shift to the occupying mode is instructed from the management authority PC 10_m. When a determination result in step SP18 is affirmative, in step SP84B, the processing circuit 21 executes management authority PC resetting processing in the second modification. The management authority PC resetting processing in the second modification is explained with reference to FIG. 14.

FIG. 14 is a flowchart illustrating an example of the management authority PC resetting processing in the second modification. The flowchart illustrated in FIG. 14 is different from the flowchart illustrated in FIG. 11 in that step SP96B is executed instead of step SP96 and FIG. 14 is ended without executing step SP100 after the end of the execution of step SP98 and is the same as the flowchart illustrated in FIG. 11 in other parts. Only the differences from the flowchart illustrated in FIG. 11 are explained below.

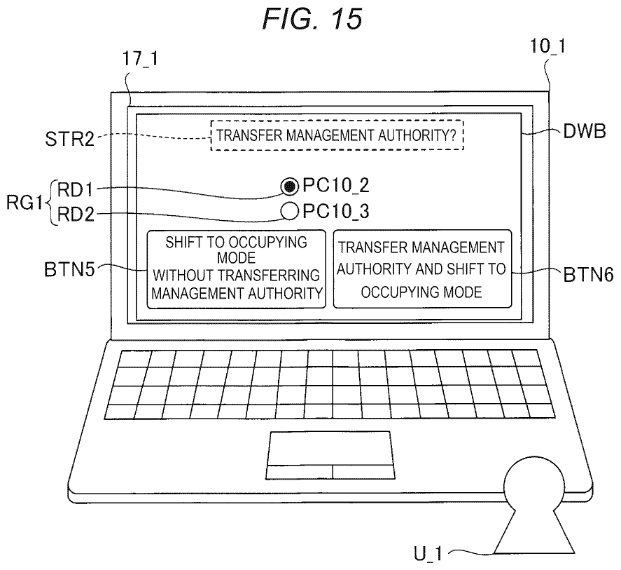

When receiving the selection instruction according to the processing in step SP92, the management authority PC 10_m generates image data indicating a selection instruction image DWB in the second modification based on the selection instruction and displays the selection instruction image DWB on the display 17. The selection instruction image DWB is explained with reference to FIG. 15.

FIG. 15 is a diagram illustrating an example of the selection instruction image DWB. The example illustrated in FIG. 15 is based on a premise that one or more PCs 10 logging in to the projector 20 are the PC 10_1, the PC 10_2, and the PC 10_3 and the management authority PC 10_m is the PC 10_1.

In the example illustrated in FIG. 15, the selection instruction image DWB includes the character string STR2, the radio button group RG1, a button BTN5, and a button BTN6. Only the differences from FIG. 12 are explained below.

The button BTN5 is a button for shifting to the occupying mode without transferring management authority. A character string “shift to the occupying mode without transferring of management authority” is displayed on the button BTN5. The button BTN6 is a button for transferring the management authority and shifting to the occupying mode. The button BTN6 displays a character string “transfer management authority and shift to the occupying mode”.

When the button BTN5 is pressed, the management authority PC 10_m transmits, to the projector 20, occupying mode shift instruction information without management authority transfer indicating an instruction to shift to the occupying mode without transferring the management authority. When the button BTN6 is pressed, the management authority PC 10_m transmits, to the projector 20, identification information of the PC 10 associated with the radio button RD selected by the presenter U at the management authority PC 10_m.

When the determination result in step SP94 is negative, in step SP96, the processing circuit 21 determines whether the occupying mode shift instruction information without management authority transfer is received. If a determination result in step SP96 is negative, the processing circuit 21 executes the processing in step SP94 again.

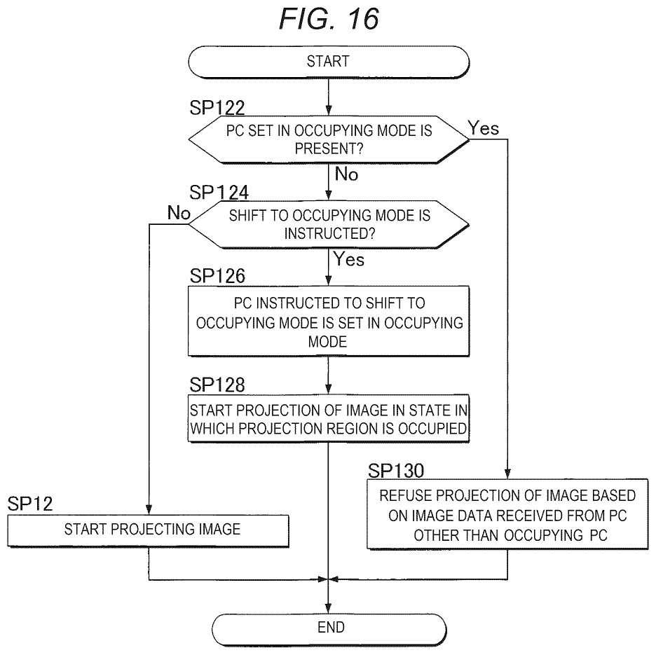

FIG. 13 is referred to again. After the processing in step SP84B ends or when the determination result in step SP18 is negative, the processing circuit 21 executes image data reception time processing in step SP22. The image data reception time processing is explained with reference to FIG. 16.

FIG. 16 is a flowchart illustrating an example of the image data reception time processing. In step SP122, the processing circuit 21 determines whether there is the PC 10 in which the occupying mode is set.

When a determination result in step SP122 is negative, in step SP124, the processing circuit 21 determines whether the presenter U at the PC 10 that transmitted the image data has instructed a shift to the occupying mode. When a determination result in step SP124 is negative, the projection device executes the processing in step SP12. After the processing in step SP12 ends, the processing circuit 21 ends a series of processing illustrated in FIG. 16.

When the determination result in step SP124 is affirmative, in step SP126, the processing circuit 21 sets, in the occupying mode, the PC 10 instructed to shift to the occupying mode. Subsequently, in step SP128, based on an instruction of the processing circuit 21, the projection device 27 starts projecting an image based on the received image data in a state of occupying the projection region PR. Specifically, when image data is received from two or more PCs 10, the projection device 27 releases the division of the projection region PR and projects an image based on image data transmitted from the PC 10 set in the occupying mode, that is, the occupying PC 10_o. In the following description, an image that the occupation PC 10_o causes the projector 20 to display is sometimes described as “occupying image”. After the processing in step SP128 ends, the processing circuit 21 ends the series of processing illustrated in FIG. 16.

The occupying image has the following two aspects. The occupying image in the first aspect is the same as the image displayed on the display 17_o of the occupying PC 10_o. The occupying image in the first aspect is sometimes described as “mirroring image”.

The occupying image in the second aspect is different from the image displayed on the display 17_o. Specifically, the occupying image in the second aspect is a partial image of the image displayed on the display 17_o. The partial image of the image displayed on the display 17_o is, for example, an image obtained by enlarging a part of the image displayed on the display 17_o or an image in a window of an application program displayed on the display 17_o. The application program may be any program and is, for example, a program for creating a document and a program for displaying a document. The occupying image in the second aspect is sometimes described as “partially occupying image”.

When the determination result in step SP122 is affirmative, in step SP130, the processing circuit 21 refuses projection of an image based on image data received from the PC 10_other than the occupying PC 10_o. After the processing in step SP130 ends, the processing circuit 21 ends the series of processing illustrated in FIG. 16.

FIG. 13 is referred to again. After the processing in step SP22 ends, the processing circuit 21 ends the processing in step SP4. The communication request reception time processing executed in step SP8 is the same as that in the first embodiment. In the processing in step SP42 in the communication request reception time processing, the communication circuit 24 transmits authorization request information to the management authority PC 10_m set in the processing in step SP96.

### 3-2-2. Summary of the Second Modification

In the following description, a summary of the second modification is explained using an example in which communication between the PC 10_1 and the projector 20 is described as first communication, communication between the PC 10_2 and the projector 20 is described as second communication, communication between the PC 10_3 and the projector 20 is described as third communication, and the PC 10_1 is set as the management authority PC 10_m.

In the display system 1 in the second modification, each of the three or more PCs 10 includes the display 17, the first communication, the second communication, and the third communication are established by the projector 20, the projector 20 sets the management authority in the PC 10_2 when the PC 10_1 is set in the occupying mode, and, when being requested from the PC 10_3 to project an image on the projection region PR while projecting an image on the projection region PR, the projector 20 refuses to display an image based on image data transmitted from PC 10_3.

According to the second modification, since the display 17 of the PC 10_2 that is not in the occupying mode displays the communication determination image CW indicated by the communication determination image data, it is possible to prevent the presenter U_1 at the PC 10_1, which is in the occupying mode, from being bothered.

The mirroring image, which is the occupying image in the first mode, is the same as the image displayed on the display 17_o of the occupying PC 10_o.

Since the presenter U_o at the occupying PC 10_o sometimes gives an explanation while viewing an image displayed on the display 17_o, if the communication determination image CW is displayed on the display 17_o, it is likely that explanation concerning the image displayed on the display 17_o is interrupted and the presenter U_o feels annoyed. Therefore, according to the second modification, since it is possible to prevent the communication determination image CW from being displayed on the same image as an image projected by the projector 20, it is possible to prevent the presenter U_o from feeling annoyed.

A partial shared image that is the shared image in the second mode is different from the image displayed on the display 17_o of the occupying PC 10_0.

A related image related to an image projected by the projector 20 is sometimes displayed on the display 17_o. The related image is, for example, one or both of an image indicating a document read out by the presenter U_o for explanation and an image indicating a timer for observing a time allocated to the presenter U_o. If the communication determination image CW is displayed on the display 17_o, it is likely that the related image is hidden by the communication determination image CW and the presenter U_o feels annoyed. According to the second modification, since it is possible to prevent the communication determination image CW from being superimposed on the related image, it is possible to prevent the presenter U_o from feeling annoyed.

### 3-3. Third Modification

A third modification is different from the second modification in that, when the occupying mode is released after the PC 10 set as the management authority PC 10_m shifts to the occupying mode and is no longer the management authority PC 10_m, the PC 10 is set as the management authority PC 10_m again. The third modification is explained below.

### 3-3-1. Operation in the Third Modification

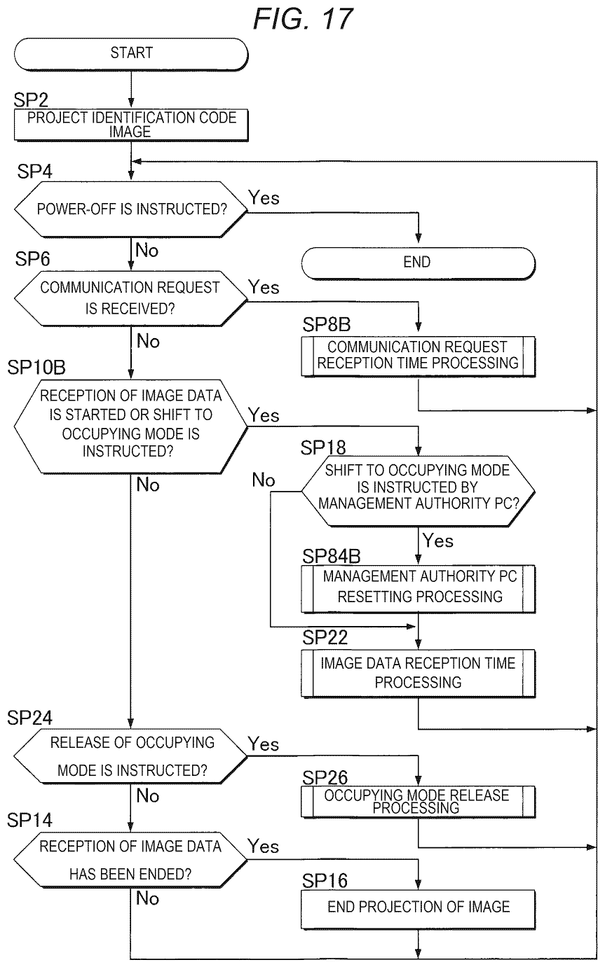

FIG. 17 is a flowchart illustrating an example of an operation of the projector 20 in the third modification. The flowchart illustrated in FIG. 17 is different from the flowchart illustrated in FIG. 13 in that processing in step SP24 is executed when the determination result in step SP10B is negative and processing in step SP26 is executed when the determination result in step SP24 is affirmative and is the same as the flowchart illustrated in FIG. 13 in other parts. Only the differences from the flowchart illustrated in FIG. 13 are explained.

When the determination result in step SP10B is negative, in step SP24, the processing circuit 21 determines whether release of the occupying mode is instructed by the presenter U at the PC 10. The instruction to release the occupying mode is, for example, a “release occupying mode” button displayed on the display 17 of the PC 10 being pressed.

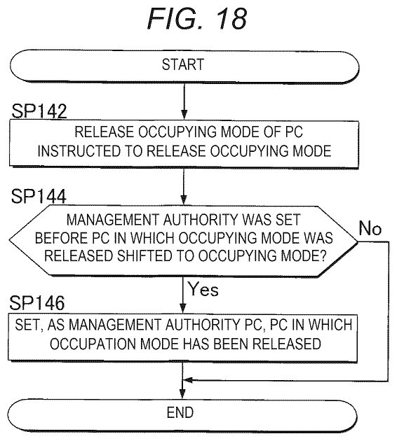

When a determination result in step SP24 is negative, the processing circuit 21 executes the processing in step SP14. When the determination result in step SP24 is affirmative, the processing circuit 21 executes occupying mode release processing in step SP26. After the processing in step SP26 ends, the processing circuit 21 executes the processing in step SP4 again. The occupying mode release processing is explained with reference to FIG. 18.

FIG. 18 is a flowchart illustrating an example of an operation of the occupying mode release processing. In step SP142, the processing circuit 21 releases the occupying mode of the PC 10 instructed to release the occupying mode. After the processing in step SP142 ends, in step SP144, the processing circuit 21 determines whether management authority was set before the PC 10 in which the occupying mode was released shifted to the occupying mode. In order to implement step SP144, in step SP98, the processing circuit 21 stores, in the storage circuit 22, identification information of the PC 10 in which the management authority was set. When the identification information stored in the storage circuit 22 and the identification information of the PC 10 in which the occupying mode has been released coincide, the processing circuit 21 determines that a determination result at step SP144 is affirmative.

When the determination result in step SP144 is affirmative, in step SP146, the processing circuit 21 sets, as the management authority PC 10_m, the PC 10 in which the occupying mode has been released. After the processing in step SP146 ends or when the determination result in step SP144 is negative, the processing circuit 21 ends a series of processing illustrated in FIG. 18.

### 3-3-2. Summary of the Third Modification

In the following description, a summary of the third modification is explained using an example in which the PC 10_1 is set as the management authority PC 10_m.

When the PC 10_1 is released from the occupying mode, the projector 20 sets the management authority in the PC 10_1 from the second communication terminal.

The presenter U at the PC 10 set in the management authority PC 10_m is most likely to be accustomed to operation of the management authority of the projector 20 among the N presenters U. Therefore, according to the third modification, it is possible to set the management authority in the PC 10 of the presenter U who is most likely to be accustomed to the operation of the management authority of the projector 20.

### 3-4. Fourth Modification

In the aspects explained above, the projector 20 is an example of the “monitor” but the monitor is not limited to the projector 20. For example, another example of the monitor may be an organic EL display or a liquid crystal display. EL is an abbreviation of Electro Luminescence.

### 3-5. Fifth Modification

In the aspects explained above, the display 17 provided in the PC 10 is explained as an example of the output destination of the information for causing the presenter U_1 to determine whether to approve authorization of communication. However, the output destination is not limited to the display 17. For example, the PC 10 includes earphones and the presenter U wears the earphones. The PC 10_may reproduce, to the earphones, voice indicating information for causing the presenter U_1 to determine whether to approve authorization of communication between the PC 10 and the projector 20 and voice for prompting approval or disapproval of the authorization of the communication. The voice indicating the information for causing the presenter U_1 to determine whether to approve the authorization of the communication between the PC 10 and the projector 20 is, for example, “Approve authorization of communication between the projector 20 and the PC 10_2?”. The voice for prompting approval or disapproval of the authorization of the communication is, for example, “Please press a determination key if you approve the authorization of the communication and press a cancel key if you disapprove the authorization of the communication”. When the decision key is pressed, the PC 10 transmits approval information to the projector 20 and, when the cancel key is pressed, the PC 10 transmits disapproval information to the projector 20.

### 3-6. Sixth Modification

In the first modification and the aspects based on the first modification, the occupying image in the second aspect is the partial image of the image displayed on the display 17_o but is not limited to this. For example, the occupying image in the second aspect may be an image obtained by superimposing another image on an image displayed on the display 17_o.

### 3-7. Seventh Modification

In the aspects explained above, “when an instruction to disconnect the first communication is received from the management authority PC 10_m” is described as an example of “in response to the first communication being disconnected”. However, a specific example of “in response to the first communication being disconnected” is not limited to “when an instruction to disconnect the first communication is received from the management authority PC 10_m”. For example, when the first communication is disconnected, the projector 20 may set the management authority in the PC 10_2. In the seventh modification, “when the first communication is disconnected” is an example of “in response to the first communication being disconnected”. “when the first communication is disconnected” includes a case in which the first communication is disconnected by receiving an instruction to disconnect the first communication from the management authority PC 10_m, a case in which the first communication is disconnected as a result of the management authority PC 10_m moving, and a case in which the first communication is disconnected because some obstacle occurs between the management authority PC 10_m and the projector 20.

Similarly, when the first communication is disconnected because of some reason in a state in which the first communication, the second communication, and the fourth communication are established, the projector 20 may set the management authority in, of the PC 10_2 and the PC 10_4, the PC 10 having high intensity of a reception signal of wireless connection or the PC 10 that established communication with the projector 20 at early time.

### 4. Appendixes

A summary of the present disclosure is appended below.
(Appendix 1) A method of, in a display system including three or more communication terminals and a monitor capable of communicating with the three or more communication terminals, controlling communication with the monitor, the method including: establishing, with the monitor capable of displaying an image in a display region, first communication with a first communication terminal in which management authority for managing authorization of communication with the monitor is set among the three or more communication terminals and second communication with a second communication terminal among the three or more communication terminals; when authorization of third communication between a third communication terminal among the three or more communication terminals and the monitor is requested from the third communication terminal while the image is displayed in the display region, transmitting, with the monitor, to a management device that is a device in which the management authority is set, authorization request information indicating that authorization of the third communication is requested; when the authorization request information is received, outputting, with the management device, to the monitor, communication determination information for causing a user of the management device to determine whether to approve the authorization of the third communication; and establishing, with the monitor, the third communication when approval information indicating that the authorization of the third communication was approved is received from the management device. According to Appendix 1, it is possible to establish communication between the third communication terminal and the monitor while preventing display, in the display region, of an image based on image data transmitted from the first communication terminal or the second communication terminal from being hindered.
(Appendix 2) The method of controlling communication with the monitor described in Appendix 1, further including setting, with the monitor, the management authority in the second communication terminal when the first communication is disconnected. According to Appendix 2, when the third communication terminal requests connection to the monitor in response to communication with the first communication terminal in which the management authority is set being disconnected, a user of the second communication terminal can determine whether to approve authorization of communication between the third communication terminal and the monitor.
(Appendix 3) The method of controlling communication with the monitor described in Appendix 1, wherein each of the three or more communication terminals includes a display, and the method further includes: establishing, with the monitor, the first communication, the second communication, and the third communication; when the first communication terminal is set in a first mode of displaying an image based on image data transmitted from one device among the three or more communication terminals in the display in an occupied manner, setting the management authority in the second communication terminal with the monitor; and when the third communication terminal requests to display an image in the display region while an image is displayed in the display region, refusing, with the monitor, to cause the monitor to display an image based on image data transmitted from the third communication terminal. According to Appendix 3, since the display of the second communication terminal that is not in the first mode displays the communication determination information, it is possible to prevent a user of the first communication terminal that is in the first mode from being bothered.
(Appendix 4) The method of controlling communication with the monitor described in Appendix 3, wherein an image that the first communication terminal causes the monitor to display is the same as an image displayed on the display of the first communication terminal. According to Appendix 4, since it is possible to prevent the communication determination information from being displayed on the same image as the image displayed by the monitor, it is possible to prevent a user of a communication terminal set in the first mode from feeling annoyed.
(Appendix 5) The method of controlling communication with the monitor described in Appendix 3, wherein an image that the first communication terminal causes the monitor to display is different from an image displayed on the display of the first communication terminal. According to Appendix 5, since it is possible to prevent the communication determination information from being superimposed and displayed on information concerning an image projected by the monitor, it is possible to prevent the user of the communication terminal set in the first mode from feeling annoyed.
(Appendix 6) The method of controlling communication with the monitor described in Appendix 3, further including, when the first communication terminal is released from the first mode, setting, with the monitor, the management authority in the first communication terminal from the second communication terminal. According to Appendix 6, it is possible to set the management authority in a device of a user who is most likely to be accustomed to operation of the management authority of the monitor.
(Appendix 7) The method of controlling communication with the monitor described in Appendix 1, further including, when, after the authorization request information was transmitted to the first communication terminal, a predetermined period elapsed without the monitor receiving both the approval information and disapproval information indicating the authorization of the third communication was disapproved, setting, with the monitor, the management authority in the second communication terminal. According to Appendix 7, when a user of the first communication terminal over looks the communication determination information or when the user of the first communication terminal is busy and cannot operate the first communication terminal, a user of another device can temporarily determine whether to approve authorization of communication between the third communication terminal and the monitor.
(Appendix 8) The method for controlling communication with a monitor described in Appendix 1, wherein the three or more communication terminals are four or more communication terminals, each of the four or more communication terminals includes an input unit, in addition to the first communication and the second communication being established, a fourth communication between a fourth communication terminal among the four or more communication terminals and the monitor is established, and, the method further includes, when an instruction to disconnect the first communication is received from the first communication terminal, setting, with the monitor, the management authority in, of the second communication terminal and the fourth communication terminal, a device specified based on an operation result of the input unit of the first communication terminal by a user of the first communication terminal during the establishment of the first communication. According to Appendix 8, when the third communication terminal requests connection to the monitor after the communication of the first communication terminal in which the management authority is set is disconnected, a user of the second communication terminal or the fourth communication terminal can determine whether to approve authorization of communication between the third communication terminal and the monitor.
(Appendix) The method of controlling communication with the monitor described in Appendix 1, wherein the three or more communication terminals are four or more communication terminals, each of the four or more communication terminals and the monitor are capable of communicating with each other by wireless communication, in addition to the first communication and the second communication being established, fourth communication between a fourth communication terminal among the four or more communication terminals and the monitor is established, and, the method further includes, when, after the authorization request information is transmitted to the first communication terminal, a predetermined period elapses while the monitor does not receive both of the approval information and disapproval information indicating that the authorization of the third communication was disapproved or in response to the first communication being disconnected, setting, with the monitor, the management authority in, of the second communication terminal and the fourth communication terminal, a device having high intensity of a reception signal of the wireless connection or a device that established communication with the monitor at early time. According to Appendix 9, when the third communication terminal requests connection to the monitor after the communication of the first communication terminal in which the management authority is set is disconnected, a user of the second communication terminal or the fourth communication terminal can determine whether to approve authorization of communication between the third communication terminal and the monitor.
(Appendix 10) A display system including: three or more communication terminals; and a monitor capable of communicating with the three or more communication terminals, wherein the monitor is capable of displaying an image in a display region, first communication between a first communication terminal among the three or more communication terminals and the monitor and second communication between a second communication terminal among the three or more communication terminals and the monitor are established, management authority for managing connection to the monitor is set in the first communication terminal, when authorization of third communication between a third communication terminal among the three or more communication terminals and the monitor is requested from the third communication terminal while the image is displayed in the display region, the monitor transmits, to a management device that is a device in which the management authority is set, authorization request information indicating that authorization of the third communication is requested, when receiving the authorization request information, the management device outputs, to the monitor, communication determination information for causing a user of the first communication terminal to determine whether to approve the authorization of the third communication, and the monitor establishes the third communication when receiving, from the management device, approval information indicating that the authorization of the third communication was approved. According to Appendix 10, the same effects as the effects of Appendix 1 are obtained.

What is claimed is:

1. A method of, in a display system including three or more communication terminals and a monitor capable of communicating with the three or more communication terminals, controlling communication with the monitor, the method comprising:
establishing, with the monitor capable of displaying an image in a display region, first communication with a first communication terminal in which management authority for managing authorization of communication with the monitor is set among the three or more communication terminals and second communication with a second communication terminal among the three or more communication terminals;
when authorization of third communication between a third communication terminal among the three or more communication terminals and the monitor is requested from the third communication terminal while the image is displayed in the display region, transmitting, with the monitor, to a management device that is a device in which the management authority is set, authorization request information indicating g that authorization of the third communication is requested;
when the authorization request information is received, outputting, with the management device, to the monitor, communication determination information for causing a user of the management device to determine whether to approve the authorization of the third communication; and
establishing, with the monitor, the third communication when approval information indicating that the authorization of the third communication was approved is received from the management device.

2. The method of controlling communication with the monitor according to claim 1, further comprising setting, with the monitor, the management authority in the second communication terminal when the first communication is disconnected.

3. The method of controlling communication with the monitor according to claim 1, wherein
each of the three or more communication terminals includes a display, and
the method further comprises:
establishing, with the monitor, first the communication, the second communication, and the third communication;
when the first communication terminal is set in a first mode of displaying an image based on image data transmitted from one device among the three or more communication terminals in the display in an occupied manner, setting the management authority in the second communication terminal with the monitor; and
when the third communication terminal requests to display an image in the display region while an image is displayed in the display region, refusing, with the monitor, to cause the monitor to display an image based on image data transmitted from the third communication terminal.

4. The method of controlling communication with the monitor according to claim 3, wherein an image that the first communication terminal causes the monitor to display is the same as an image displayed on the display of the first communication terminal.

5. The method of controlling communication with the monitor according to claim 3, wherein an image that the first communication terminal causes the monitor to display is different from an image displayed on the display of the first communication terminal.

6. The method of controlling communication with the monitor according to claim 3, further including, when the first communication terminal is released from the first mode, setting, with the monitor, the management authority in the first communication terminal from the second communication terminal.

7. The method of controlling communication with the monitor according to claim 1, further comprising, when, after the authorization request information was transmitted to the first communication terminal, a predetermined period elapsed without the monitor receiving both the approval information and disapproval information indicating the authorization of the third communication was disapproved, setting, with the monitor, the management authority in the second communication terminal.

8. The method for controlling communication with a monitor according to claim 1, wherein
the three or more communication terminals are four or more communication terminals,
each of the four or more communication terminals includes an input unit,
in addition to the first communication and the second communication being established, a fourth communication between a fourth communication terminal among the four or more communication terminals and the monitor is established, and
the method further comprises, when an instruction to disconnect the first communication is received from the first communication terminal, setting, with the monitor, the management authority in, of the second communication terminal and the fourth communication terminal, a device specified based on an operation result of the input unit of the first communication terminal by a user of the first communication terminal during the establishment of the first communication.

9. The method of controlling communication with the monitor according to claim 1, wherein
the three or more communication terminals are four or more communication terminals,
each of the four or more communication terminals and the monitor are capable of communicating with each other by wireless communication,
in addition to the first communication and the second communication being established, fourth communication between a fourth communication terminal among the four or more communication terminals and the monitor is established, and
the method further comprises, when, after the authorization request information is transmitted to the first communication terminal, a period elapses while the monitor does not receive both of the approval information and disapproval information indicating that the authorization of the third communication was disapproved or in response to the first communication being disconnected, setting, with the monitor, the management authority in, of the second communication terminal and the fourth communication terminal, a device having high intensity of a reception signal of the wireless connection or a device that established communication with the monitor at early time.

10. A display system comprising:
three or more communication terminals; and
a monitor capable of communicating with the three or more communication terminals, wherein
the monitor is capable of displaying an image in a display region,
first communication between a first communication terminal among the three or more communication terminals and the monitor and second communication between a second communication terminal among the three or more communication terminals and the monitor are established,
management authority for managing connection to the monitor is set in the first communication terminal, when authorization of third communication between a third communication terminal among the three or more communication terminals and the monitor is requested from the third communication terminal while the image is displayed in the display region, the monitor transmits, to a management device that is a device in which the management authority is set, authorization request information indicating that authorization of the third communication is requested,
when receiving the authorization request information, the management device outputs, to the monitor, communication determination information for causing a user of the first communication terminal to determine whether to approve the authorization of the third communication, and
the monitor establishes the third communication when receiving, from the management device, approval information indicating that the authorization of the third communication was approved.
